(19) United States
(12) Patent Application Publication
(10) Pub. No.: US 2014/0083869 A1
(43) Pub. Date: Mar. 27, 2014

(54) Detection Of Endotoxins

(71) Applicants: Sanjeev K. Manohar, Nashua, NH (US); Srikanth Ammu, Morrisville, NC (US); Syed K. Hasan, Lowell, MA (US)

(72) Inventors: Sanjeev K. Manohar, Nashua, NH (US); Srikanth Ammu, Morrisville, NC (US); Syed K. Hasan, Lowell, MA (US)

(73) Assignee: UNIVERSITY OF MASSACHUSETTS, Boston, MA (US)

(21) Appl. No.: 13/984,727

(22) PCT Filed: Feb. 9, 2012
(86) PCT No.: PCT/US12/24530

§ 371 Date: Dec. 16, 2013

(30) Foreign Application Priority Data
Feb. 9, 2011 (US) 61441174

(51) Int. Cl. G01N 27/327

(52) U.S. Cl. CPC G01N 27/327
USPC 205/782; 530/350; 536/6.5; 525/54.1; 204/403.01

(57) ABSTRACT

A complex comprises a polyene macrolide antibiotic and an endotoxin. Methods and devices detect the complex. A polymeric material functionalized with a polyene macrolide antibiotic is employed in the devices.

### RELATED APPLICATIONS

This application claims the benefit of U.S. Provisional Application No. 61/441,174, filed Feb. 9, 2011.

### GOVERNMENT SUPPORT

This invention was made with government support under Grant No. W911NJ-09-2-0046 awarded by the U.S. Army Research Office. The government has certain rights in the invention.

This application relates to U.S. Provisional Application No. ______, attorney docket 0813.2056-000, entitled “Double-reduced Graphene Oxide,” filed Feb. 9, 2012.

The entire teachings of these applications are incorporated herein by reference.

### BACKGROUND OF THE INVENTION

Endotoxins are ubiquitous pyrogens typically found in the cell wall of gram-negative bacteria, such as Escherichia coli and pseudomonas. Endotoxins are also a major cause of septicemia and include a broad category of compounds called lipopolysaccharides (LPS). LPS constitute a major component of bacterial cell walls and induce actin reorganization, increased paracellular permeability and endothelial cell detachment from the underlying extracellular matrix. Actively dividing bacteria in bodily fluids release LPS from the cell walls. Free-floating LPS within extracellular spaces and fluids triggers inflammatory responses by local tissues and immune cells. The inflammatory response is marked by a cellular outpouring of cytokines into the localized area of tissues, which in turn attracts more immune cells to ward off the bacteria. This chain of events creates a cyclic pattern whereby cytokines continue to be released into the local area of infection and more immune cells are attracted to kill bacteria from the tissue. As this process continues unabated, capillaries become leaky and expel intracellular fluid into the extracellular compartment, thus leading to edema of tissues and organs. If the situation cannot be stopped, it can result in organ damage and, ultimately, death.

In addition, bacterial contamination is a major issue in the pharmaceutical and food and beverage industries and there are considerable costs associated with its detection and removal.

The current industry standard to measure endotoxin levels is the limulus ambeocyte lysate (LAL) test, which requires the use of blood from horseshoe crab. The cost of one quart of horseshoe crab blood is approximately $15,000. With the horseshoe crab population on the decline and the risk of population wipeout by a single disease or other environmental threat, supply of horseshoe crab blood has become an issue. The LAL test is also cumbersome to set up, prone to false negatives, and cannot be used to detect LPS in real time.

Therefore, there is a need for a sensor, device, and method that can overcome or minimize the above-mentioned deficiencies in the detection of bacterial toxins, such as those that cause sepsis.

### SUMMARY OF THE INVENTION

In one example embodiment, the present invention is a complex, comprising: a polyene macrolide antibiotic and an endotoxin. For example, the complex of the above-described embodiment can include the endotoxin selected from the group consisting of a lipopolysaccharide and a δ-endotoxin. Any of the above described embodiments can include the polyene macrolide antibiotic selected from the group consisting of amphotericin B, natamycin and nystatin. In one embodiment, the endotoxin is a lipopolysaccharide and the polyene macrolide antibiotic is a polyene macrolide antibiotic from a gram negative bacterium, for example, amphotericin B or nystatin. In another embodiment, the endotoxin is a δ-endotoxin and the polyene macrolide antibiotic is a polyene macrolide antibiotic from a gram positive bacterium, for example, natamycin.

In any of the above-described embodiments, a polymeric material can be functionalized with the polyene macrolide antibiotic. In any of the above-described embodiments, the polymeric material can include a material selected from the group consisting of polyaniline, polypyrrole, polythiophene and polyethylenedioxythiophene, or a ring- or an N-substituted derivative thereof, for example, polyaniline. Alternatively, in any of the above-described embodiments, the polymeric material can include a nanotube or a double-reduced graphene oxide.

In an example embodiment, the present invention is a sensor, comprising: a polymeric material functionalized with a polyene macrolide antibiotic. The polymeric material can include the polymeric material selected from the group consisting of polyaniline, polypyrrole, polythiophene, and polyethylenedioxythiophene, or a ring- or N-substituted derivative thereof, a carbon nanotube and a double-reduced graphene oxide. In any of the above-described embodiments, the polymeric material functionalized with a polyene macrolide antibiotic includes a thin film or a nanofiber.

In an example embodiment, the present invention is a device, comprising: a) a polymeric material functionalized with a polyene macrolide antibiotic; and b) a substrate in contact with the polymeric material. Examples of the polyene macrolide antibiotic include amphotericin B or natamycin. In any of the above-described embodiments, the polymeric material can include a material selected from the group consisting of a nanotube and a double-reduced graphene oxide. Alternatively, the polymeric material can include the polymeric material selected from the group consisting of polyaniline, polypyrrole, polythiophene and polyethylenedioxythiophene, or a ring- or N-substituted derivative thereof. In any of the above-described embodiments, the device can further include an anode and a cathode, wherein the anode, the cathode, and the polymeric material are configured to be in electrical communication with each other. In any of the above-described embodiments, the substrate can be cloth, paper or plastic.

In an example embodiment, the present invention is an electrochemical device, comprising a) a working electrode, said working electrode including a polymeric material functionalized with a polyene macrolide antibiotic; b) a counter electrode; and c) a reference electrode interposed between the working electrode and the counter electrode. In any of the above-described example embodiments, the polymeric material is a conducting polymer. In any of the above-described embodiments, the working electrode further includes a substrate in contact with the polymeric material.

In an example embodiment, the present invention is a method of detecting at least one endotoxin in a sample, comprising the steps of a) contacting a sensor with a sample, said sensor including a polyene macrolide antibiotic that binds to an endotoxin; and b) measuring a signal produced by the sensor, thereby determining whether the endotoxin is present in the sample. Examples of the endotoxins include a lipopolysaccharide or a δ-endotoxin. In any of the above-described embodiments, the method can further include the step of measuring a baseline signal produced by the sensor in the absence of the sample. In any of the above-described embodiments, the signal can be an optical signal selected from the group consisting of absorbance, fluorescence and luminescence. In any of the above-described embodiments, the sensor can further include a polymeric material functionalized with the polyene macrolide antibiotic.

In any of the above-described embodiments, the sensor can be a chemiresistor, whereby the signal is resistance of the polymeric material, and the value of the resistance of the polymeric material is dependent upon the amount of endotoxin bound to the polyene macrolide antibiotic.

In any of the above-described embodiments, the sensor can be an electrochemical sensor, whereby the signal is electrical potential of at least a portion of the electrochemical sensor, and the value of the electrical potential of at least a portion of said electrochemical sensor is dependent upon the amount of the endotoxin bound to the polyene macrolide antibiotic.

In an example embodiment, the present invention is a method for identifying an endotoxin in a sample, comprising the steps of a) contacting a sensor with a sample, said sensor including a polyene macrolide antibiotic that selectively binds to an endotoxin; and b) measuring a signal produced by the sensor, thereby determining the identity of the endotoxin in the sample.

In an example embodiment, the present invention is a method for quantifying the amount of an endotoxin in a sample, the method comprising a) contacting a sensor with a sample, said sensor including a polyene macrolide antibiotic that binds to an endotoxin; b) measuring a signal produced by the sensor; and c) comparing the signal to a standard curve, thereby determining the amount of the endotoxin in the sample.

In an example embodiment, the present invention is a method for detecting the presence of two or more different endotoxins in a sample, the method comprising a) contacting an array of at least a first sensor comprising at least a first polyene macrolide antibiotic and at least a second sensor comprising at least a second polyene macrolide antibiotic with a sample, wherein each of at least the first and at least the second polyene macrolide antibiotics selectively binds to at least a first and at least a second endotoxin, respectively, wherein at least the first endotoxin is different from at least the second endotoxin; and b) measuring a signal produced by at least the first and at least the second sensors, thereby determining whether two or more different endotoxins are present in the sample.

In an example embodiment, the present invention is a method for quantifying the amounts of two or more different endotoxins in a sample, the method comprising a) contacting an array of at least a first sensor comprising at least a first polyene macrolide antibiotic and at least a second sensor comprising at least a second polyene macrolide antibiotic with a sample, wherein each of at least the first and at least the second polyene macrolide antibiotics selectively binds to at least a first and at least a second endotoxin, respectively, wherein at least the first endotoxin is different from at least the second endotoxin; b) measuring a signal produced by at least the first and at least the second sensors; and c) comparing the signal produced by at least the first and at least the second sensors to at least a first and at least a second standard curve, respectively, thereby quantifying the amounts of two or more different endotoxins in the sample.

In an example embodiment, the present invention is a chemiresistor, comprising a thin film of double-reduced graphene oxide in electrical communication with an instrument that measures electrical resistance of double-reduced graphene oxide. The chemiresistor can further include a substrate in contact with the thin film of double-reduced graphene oxide. In any of the above-described embodiments, examples of the substrate include plastic, glass, or paper.

In an example embodiment, the present invention is a method of detecting an analyte in a sample, the method comprising a) contacting a sensor with a sample, said sensor including a thin film of double-reduced graphene oxide; and b) measuring the electrical resistance of the sensor, thereby determining whether an analyte is present in the sample. For example, the electrical resistance of at least a portion of the thin film can change in response to the analyte.

In any of the above-described embodiments, the thin film of double-reduced graphene oxide can be functionalized with a polyene macrolide antibiotic and the analyte can be an endotoxin.

In any of the above-described embodiments, the polymeric material can be a conducting polymer.

In any of the above-described embodiments, the polymeric material can be functionalized with a plurality of different polyene macrolide antibiotics. Alternatively, the polymeric material is functionalized with a single type of polyene macrolide antibiotic.

In any of the above-described embodiments, the endotoxin can be a lipopolysaccharide or a δ-endotoxin.

In any of the above-described embodiment, the polyene macrolide antibiotic can be amphotericin B, nystatin, or natamycin.

Sensors of the invention enable real-time detection of LPS. Devices of the invention incorporating these sensors are portable and lightweight, and give reliable results with a single measurement. Such a sensor could be placed, for example, with a soldier's food-and-supplies backpack and would enable early detection of septicemia. Importantly, the sensors are insensitive to potential biological interferents, like the serum proteins found in bovine serum albumin (Examples 3, 6). The detection limit of the sensors of the present invention rivals that of other commercially available methods for detecting endotoxins (Examples 1-5), such as the horseshoe crab method and electrochemical methods using LPS binding protein (See, for example, Johnny W. Peterson, Medical Microbiology, Chapter 7 (Samuel Baron, ed.) 4^{th} Edition 1996), with the added advantage that the sensors of the present invention achieve this limit in real-time (Examples 2-5).

Sensors of the invention can be incorporated into devices for detecting LPS. The resulting devices significantly improve the detection limit, and hence the utility, of these diagnostic tools. Examples 3-5 illustrates that the value of the electrical resistance of the chemiresistors of the present invention increases markedly in response to increasing amounts of LPS. Similarly, the electroactivity of the electrochemical sensors of the present invention increases in response to increasing amounts of LPS, and the conductivity of amphotericin B-seeded polyaniline is approximately one order of magnitude higher than an unseeded control (Example 2).

An additional advantage of the sensors of the present invention is resistance to detector fouling. Typically, fouling is caused by the formation of a biofilm, such as algae, on the surface of the sensor. However, the use of polyene macrolide antibiotics on the surface of a sensor precludes the formation of the biofilm and prevents sensor fouling.

An optical LPS detection system, such as the one described in Example 1, is separate from the electrical and electrochemical systems, and is well suited for use in the pharmaceutical industry, where the detection of bacterial toxins is critical.

### BRIEF DESCRIPTION OF THE FIGURES

FIG. 1 is one embodiment of a device (10) of the present invention and shows a polymeric material (11) functionalized with amphotericin B (AmB) (13) and a substrate (12) in contact with the polymeric material.

FIG. 2 is one embodiment of a three-electrode device (214) of the present invention and shows a working electrode (210), a counter electrode (215), a reference electrode (216) and an electrolyte (217).

FIG. 3A is a fluorescence spectrum of amphotericin B (AmB) as a function of wavelength (nm), and shows the fluorescence of amphotericin B (AmB) in the absence of LPS and upon exposure to concentrations of LPS ranging from 1 part per trillion (ppt) to 500 parts per billion (ppb) (λ_{excitation}=350 nm).

FIG. 3B is a fluorescence spectrum of amphotericin B as a function of wavelength (nm), and shows the fluorescence of amphotericin B upon exposure to concentrations of LPS ranging from 1 part per million (ppm) to 500 ppm (λ_{excitation}=350 nm).

FIG. 4A is an absorbance spectrum of amphotericin B (AmB) as a function of wavelength (nm) and shows the absorbance (arbitrary units) of amphotericin B (AmB) in the absence of LPS and upon exposure to concentrations of LPS ranging from 1 ppt to 500 ppb.

FIG. 4B is an absorbance spectrum of amphotericin B as a function of wavelength (nm) and shows the absorbance (arbitrary units) of amphotericin B upon exposure to concentrations of LPS ranging from 1 ppm to 500 ppm.

FIG. 5 is a potential (V)-time (minutes) profile of a conventional oxidative polymerization reaction of aniline to form polyaniline (PANI) and an oxidative polymerization reaction of aniline seeded with amphotericin B to form PANI-AmB.

FIG. 6 is an absorbance spectrum of PANI and shows the absorbance (AU) of PANI over a range of wavelengths (nm).

FIG. 7 is an absorbance spectrum of PANI-AmB conjugate and shows the absorbance (AU) of the PANI-amphotericin B conjugate over a range of wavelengths (nm).

FIG. 8 is a cyclic voltammogram of the first redox cycle of PANI-AmB upon successive additions of LPS (1=no LPS; arrow indicates increasing concentrations of LPS).

FIG. 9 is a cyclic voltammogram of both redox cycles of PANI-AmB upon successive additions of LPS (arrow indicates increasing concentrations of LPS).

FIG. 10 is a graph of the resistance (KΩ) of a single-walled carbon nanotube-amphotericin B sensor upon successive additions of LPS as a function of time (minutes).

FIG. 11 is a graph of the resistance (MΩ) of a single-walled carbon nanotube-amphotericin B sensor (CNT-AmB) and a single-walled carbon nanotube (CNT) upon successive additions of LPS as a function of time (minutes).

FIG. 12A is a graph obtained using x-ray photoelectron spectroscopy (XPS) of the counts of the carbon peak of graphene oxide (GO) reduced using ascorbic acid as a function of binding energy (eV).

FIG. 12B is a graph obtained using XPS of the counts of the carbon peak of double-reduced graphene oxide (d-RGO) as a function of binding energy (eV).

FIG. 13A is a graph of the resistance (MΩ) of an amphotericin B-functionalized double-reduced graphene oxide (d-RGO) chemiresistor upon successive additions of 0.05 EU/mL LPS (red line) and upon successive additions of 0.05 EU/mL LPS alternating with washes in 3 M aqueous NaOH to reverse the signal (black line) as a function of time (minutes).

FIG. 13B is a graph of the resistance (MΩ) of a nystatin-functionalized double-reduced graphene oxide (d-RGO) chemiresistor upon successive additions of 0.05 EU/mL LPS (red line) and upon successive additions of 0.05 EU/mL LPS alternating with washes in 3 M aqueous NaOH to reverse the signal (black line) as a function of time (minutes).

FIG. 14 is a graph of the resistance (MΩ) of an amphotericin B-functionalized d-RGO film on polyethylene terephthalate (PET) upon successive additions of LPS and upon washing in 3 M NaOH as a function of time (the numbers indicated on the graph indicate the concentration of LPS in EU/mL).

FIG. 15A is a cyclic voltammogram of an aniline tetramer-amphotericin B conjugate upon successive additions of LPS (arrow indicates increasing concentration of LPS).

FIG. 15B is a plot of percent change in the current response of an aniline tetramer-amphotericin B conjugate during cyclic voltammetry as a function of concentration of LPS (the linear response at low LPS concentrations is indicated by a solid line and the linear response at high LPS concentrations is indicated by a dashed line).

FIG. 16 is a fluorescence spectrum of natamycin as a function of wavelength (nm), and shows the fluorescence of natamycin upon exposure to concentrations of δ-endotoxin ranging from 1 part per trillion (ppt) to 500 ppm (λ_{excitation}=310 nm).

### DETAILED DESCRIPTION OF THE INVENTION

A description of example embodiments of the invention follows.

The present invention is directed to the detection of endotoxins, such as LPS, using polyene macrolide antibiotics. As used herein, the term “polyene macrolide antibiotic” refers to antimicrobial compounds, or analogs thereof, having a macrocycle with at least 7 ring atoms and not more than 50 ring atoms, preferably with at least 20 ring atoms and not more than 40 ring atoms, said macrocycle including an ester linkage and a polyene in the cycle. The family of polyene macrolide antibiotics includes, but is not limited to, amphotericin B, nystatin, natamycin, pimaricin, filipin, hamycin, perimycin, rimocidin, candicidin, methyl partricin, and trichomycin. In some embodiments, the invention is directed to the detection of endotoxins using amphotericin B or nystatin. In some embodiments, the invention is directed to the detection of endotoxins using natamycin.

As used herein, the singular forms “a,” “an” and “the” include plural referents unless the context clearly dictates otherwise. Thus, for example, reference to “polyene macrolide antibiotic” can include a plurality of such molecules. Further, the plurality can comprise more than one of the same molecule or a plurality of different molecules.

One embodiment of the present invention is a complex comprising an endotoxin and a polyene macrolide antibiotic. In some embodiments of the invention, the endotoxin is a LPS or a δ-endotoxin. In other embodiments, the polyene macrolide antibiotic is amphotericin B, nystatin or natamycin. In yet other embodiments, the endotoxin is a LPS and the polyene macrolide antibiotic is amphotericin B or nystatin. Alternatively, the endotoxin is a δ-endotoxin and the polyene macrolide antibiotic is natamycin.

The complex can further include a polymeric material functionalized with the polyene macrolide antibiotic. The polymeric material can be an electronically-conducting polymeric material, for example, polyaniline (PAM), polypyrrole, polythiophene, polyethylenedioxythiophene (PEDOT), or ring and/or N-substituted derivatives thereof. More particularly, the polymeric material is PAM, polypyrrole, or a ring- or N-substituted derivative thereof.

As used herein, “electronically-conducting polymeric material” refers to a material composed of two or more covalently-connected repeating structural units that conducts electric current. Other examples of electronically-conducting polymers include, but are not limited to carbon black, nanotubes, nanofibers, graphite, and graphene. In some embodiments of the present invention, the conducting polymeric material is conducting under physiological conditions (e.g., neutral pH, body temperatures). In other embodiments, the polymeric material is electronically-conducting at ambient temperatures.

In some embodiments of the present invention, the polymeric material functionalized with a polyene macrolide antibiotic is a thin film or a fiber. As used herein, the term “thin film” refers to a layer of a substance that is just a few atoms, or a few microns, thick.

The term “fiber,” as used herein, refers to a material that has a filamentous or elongated, thread-like structure. In some embodiments of the invention, the fiber is a nanofiber. Typically, nanofibers have a diameter of less than about 1 micron.

In some embodiments of the invention, the polymeric material is a nanotube, such as a carbon nanotube (e.g., a single-walled carbon nanotube).

In other embodiments of the invention, the polymeric material is graphene. As used herein, “graphene” refers to both single-layer and few-layer (e.g., 2-10, 3-10) thick planar sheets of sp²-bonded carbon atoms that are arranged in a honeycomb pattern. Graphene typically contains defects, such as oxygen- or nitrogen-centered defects, that are the result of incomplete reduction of graphene oxide (GO) in the synthesis of graphene. “Graphene” is meant to encompass these species as well.

“Double-reduced graphene oxide” or “d-RGO,” as used herein, refers to few-layer thick graphene that has a substantially reduced number of defects, e.g., is essentially defect-free. X-ray photoelectron spectroscopy (XPS) can be used to detect defects, such as the presence of C—O, C—N, C═O, and C(O)O functional groups, in graphene. d-RGO characterized using XPS has a carbon peak centered at approximately 285 eV that is approximately symmetrical. Because peaks corresponding to oxygen-based defects appear, in an XPS spectrum, in the same region as the C—C peak, the presence of oxygen-based defects appears as a shoulder on the C—C peak, distorting the symmetry of the peak. The lack of such a shoulder is, therefore, indicative of the efficiency of the double reduction of graphene oxide and the purity of the resulting d-RGO. Other techniques that can be used to characterize the d-RGO of the present invention include, but are not limited to, x-ray diffraction and Raman spectroscopy.

“Graphite,” as used herein, refers to more than ten stacked layers of graphene.

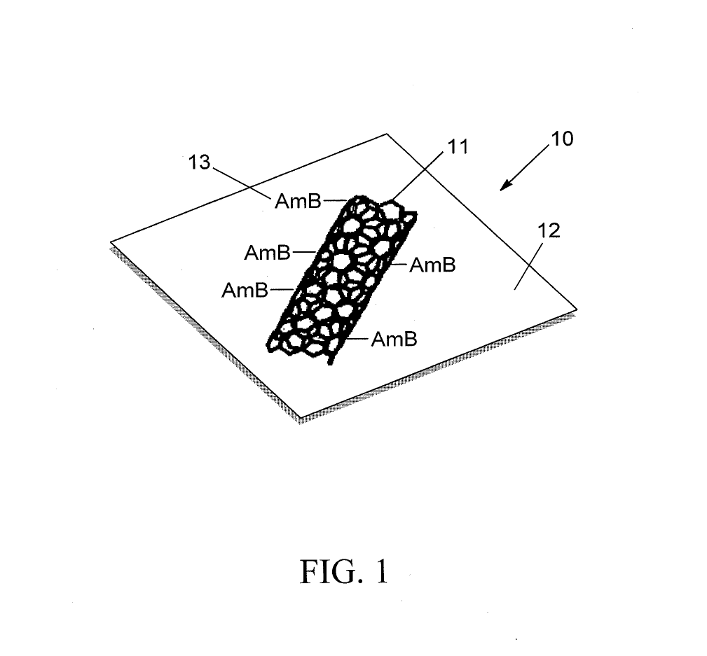

Another embodiment of the present invention is device 10, shown in FIG. 1. Device 10 comprises polymeric material 11 functionalized with a polyene macrolide antibiotic, such as amphotericin B (13), and substrate 12 in contact with polymeric material 11. As used herein, “substrate” refers to a solid support in contact with the polymeric material. In some embodiments, the substrate and the polymeric material are not covalently attached to one another. In some embodiments, the substrate can be flexible and/or disposable. The substrates of the present invention can include insulating materials (e.g., plastic, for example polyethylene terephthalate, paper, cloth, and ceramic) and/or conducting materials (e.g., platinum, graphite, graphene, glassy carbon, gold, nanotubes, and indium-tin-oxide). Other examples of substrates include, but are not limited to, plastic or glass coated with a conducting material.

As used herein, the term “functionalized” refers both to (1) the covalent attachment of a polyene macrolide antibiotic to a polymeric material, as might be achieved, for example, by chemical reaction, and (2) the noncovalent attachment of a polyene macrolide antibiotic to a polymeric material, as might be achieved, for example, by surface adsorption or immobilization. Covalent attachment of a polyene macrolide antibiotic to a polymeric material can be achieved, for example, by seeding a polymerization reaction (e.g., polymerization of aniline to form PANI) with a polyene macrolide antibiotic (e.g., amphotericin B). Non-covalent attachment of a polyene macrolide antibiotic to a polymeric material can be achieved, for example, by sonicating an aqueous mixture of the polymeric material (e.g., carbon nanotube) and a polyene macrolide antibiotic (e.g., amphotericin B) or immobilizing a polyene macrolide antibiotic in a polymeric material.

In some embodiments, the polymeric material is functionalized with one type of polyene macrolide antibiotic. In other embodiments, the polymeric material is functionalized with a plurality (i.e., more than one) of different polyene macrolide antibiotics. The plurality of different polyene macrolide antibiotics can be randomly distributed on the surface of a polymeric material or each polyene macrolide antibiotic can be localized in a distinct location on the surface of the polymeric material, for example, to form a pattern (e.g., an interdigitated array).

In one embodiment of the present invention, the device is a chemiresistor comprising a polymeric material functionalized with a polyene macrolide antibiotic and a substrate in contact with the polymeric material. As used herein, “chemiresistor” refers to a device wherein the value of the electrical resistance of the polymeric material is dependent upon the amount of an analyte (e.g., endotoxin) bound to the polymeric material or to the polyene macrolide antibiotic-functionalized polymeric material. In some embodiments, the chemiresistors of the present invention further include a substrate (e.g., plastic, cloth, paper, or ceramic) in contact with the polymeric material. Alternatively, the chemiresistor can include a non-woven interpenetrating network of a polymeric material functionalized with a polyene macrolide antibiotic on a gold interdigitated array.

In one embodiment, the chemiresistor comprises a nanotube functionalized with a polyene macrolide antibiotic, for example, by surface adsorption. The carbon nanotubes can be debundled, such that they are in the form of single nanotubes (s-nanotubes), they can be partially bundled, or they can be bundled. Typically, functionalization of the nanotubes occurs on the surface of the tube or bundle exposed to the environment. Single nanotubes have a greater effective surface area compared to bundled nanotubes. Because a single nanotube has a larger surface area exposed to the environment than a bundle of nanotubes, single nanotubes can be functionalized with more polyene macrolide antibiotic and, in turn, more LPS than their bundled counterparts. Greater amounts of LPS binding to the nanotubes cause larger sensor signals. Larger sensor signals, in turn, result in more sensitive devices and lower detection limits.

In another embodiment, the chemiresistor comprises a thin film of d-RGO in electrical communication with an instrument that measures electrical resistance of d-RGO. In some embodiments, the chemiresistor further includes a substrate in contact with the thin film of d-RGO.

The d-RGO-based chemiresistors of the invention can be exposed to aqueous base, ultraviolet (UV) light, or UV irradiation in order to induce signal recovery. Thus, in some embodiments of the invention, the chemiresistor is re-usable.

In still another embodiment of the present invention, the device is an electrochemical device comprising a polymeric material functionalized with a polyene macrolide antibiotic and a substrate in contact with the polymeric material. As used herein, “electrochemical device” refers to a device wherein the value of electrical potential is dependent upon the amount of endotoxin bound to the polyene macrolide antibiotic.

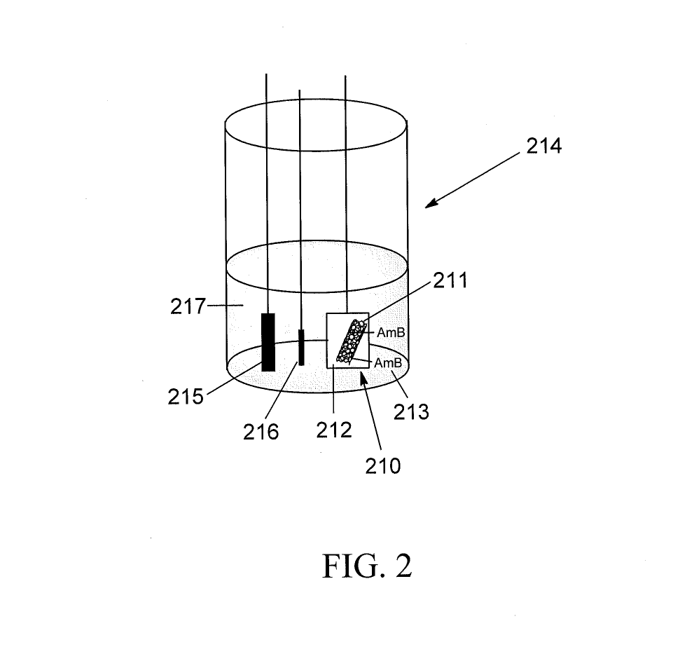

In one embodiment of the invention, depicted in FIG. 2, the electrochemical device 214 comprises electrolyte 217 and three electrodes: a working electrode 210, a counter electrode 215, and a reference electrode 216 interposed between the working electrode 210 and the counter electrode 215. The electrolyte is a substance that has free ions and is electrically conductive. In some embodiments of the invention, the electrolyte is an ionic solution, such as aqueous acid. The working electrode includes a substrate (e.g., platinum foil) and a polymeric material (e.g., PANI) functionalized with a polyene macrolide antibiotic (e.g., amphotericin B). The reference electrode typically has a well-known and stable equilibrium potential and can, therefore, be used to provide a reference potential against which the potential of the working electrode can be measured. The counter electrode can be, for example, a platinum wire, and the reference electrode can be, for example, silver/silver chloride. Other substrate materials include, but are not limited to, graphite, graphene, glassy carbon, gold, plastic or glass coated with indium-tin-oxide, and carbon nanotubes. In some embodiments, the working electrode is the substrate.

In yet another embodiment, the device is an optical device, comprising a transparent substrate functionalized with a polyene macrolide antibiotic. In this embodiment, a polyene macrolide antibiotic, such as amphotericin B, can be immobilized in a polymeric medium (e.g., polyvinylalcohol) and adsorbed onto a transparent substrate, such as a membrane having a transparent backing. In use, the area of the substrate functionalized with the polyene macrolide antibiotic is contacted with a sample, while the transparent area of the substrate is in optical communication with, for example, a fiberoptic assembly. The optode can be interrogated by frequency modulated excitation light delivered via a fiberoptic assembly. Upon endotoxin-polyene macrolide antibiotic binding, the phase shift of the quenched emitted signal can be analyzed via a computer-controlled meter to yield the concentration of endotoxin. Signal enhancement could potentially be achieved through the use of an endotoxin-insensitive fluorophore reference.

Alternatively, ratiometric fluorescence or luminescent lifetime decay to of the signal produced by the polyene macrolide antibiotic can be measured. In ratiometric fluorescence, the ratio of two fluorescent signals for a given parameter-sensitive dye, or a combination of parameter-sensitive dyes, is obtained. In luminescent lifetime decay, the dynamic luminescent quenching of a fluorophore, such as a polyene macrolide antibiotic, by a molecule, such as an endotoxin, is monitored. Unlike ratiometric fluorescence monitoring, endotoxin detection by luminescent lifetime decay is far less susceptible to fluorescence intensity fluctuations caused by photobleaching or non-specific matrix absorption. Luminescent liftetime decay takes advantage of the fact that the collision between an immobilized fluorophore (e.g., polyene macrolide antibiotic) and the parameter of interest (e.g., endotoxin) results in dynamic quenching. After the collision, energy is transferred from the excited indicator dye to the parameter. As a result, the fluorophore does not emit fluorescence and the fluorescence signal decreases. A relationship can be established between endotoxin concentration and the fluorescence intensity of the dye, as well as the fluorescence lifetime, which is described by the Stern-Volmer equation, reproduced below:

$$\frac{Fo}{F} = 1 + {K}_{SV} [ Q ] ,$$

where Fₒ is the unquenched fluorescence intensity, F is the fluorescence intensity at [Q], [Q] is the quencher concentration, K_{SV} is the Stern-Volvmer quenching constant, and K_{SV}=k_{q}τₒ, where k_{q} is the bimolecular quenching constant and τₒ is the fluorescence lifetime in the absence of quencher.

One embodiment of the present invention is a sensor comprising a polymeric material functionalized with a polyene macrolide antibiotic. In some embodiments, the polymeric material is selected from the group consisting of polyaniline, polypyrrole, polythiophene and polyethylenedioxythiophene, or a ring- or N-substituted derivative thereof. In some embodiments, the polymeric material functionalized with a polyene macrolide antibiotic is a thin film or a nanofiber.

One method of forming a thin film of the invention is by printing an aqueous dispersion of the polymeric material functionalized with a polyene macrolide antibiotic onto a flexible substrate (e.g., plastic, cloth, or paper) using, for example, an inkjet printer. The aqueous dispersion can further include a surfactant, such as the nonionic surfactant polyethylene glycol p-(1,1,3,3-tetramethylbutyl)-phenyl ether (Triton X-100).

Thin films of the invention can also be formed by casting a solution of the polymeric material in a polar, organic solvent onto a substrate. For example, a solution of PAM functionalized with a polyene macrolide antibiotic in N-methyl-2-pyrrolidone (NMP) can be cast onto platinum mesh to form a thin film. Examples of polar organic solvents include, but are not limited to, NMP, dimethylsulfoxide, formamide, alcohols (e.g., methanol, ethanol), and ethers (e.g., tetrahydrofuran, diethyl ether). Thin films of the invention can also be cast as a suspension in water or mixtures of water and a polar organic solvent.

In some embodiments, the present invention is a method of detecting an endotoxin in a sample using a polyene macrolide antibiotic. The method comprises contacting the polyene macrolide antibiotic that binds to an endotoxin with a sample and measuring a signal produced by the polyene macrolide antibiotic. In other embodiments, the method further includes the step of measuring a baseline signal produced by the polyene macrolide antibiotic in the absence of sample. In yet other embodiments, the method further includes a pre-equilibration step to establish a baseline signal produced by the polyene macrolide antibiotic. In one embodiment, the pre-equilibration step includes exposing a sensor including a polyene macrolide antibiotic to a high concentration of analyte (e.g., endotoxin) to condition the sensor.

A polyene macrolide antibiotic “binds to” an endotoxin if the dissociation constant (K_{d}) of the interaction between the two species is less than about 10 μM, less than about 1 μM, or less than about 100 nM. A polyene macrolide antibiotic “selectively binds to” or “is selective for” an endotoxin if the polyene macrolide antibiotic binds to its at least one cognate endotoxin to a greater extent than at least one other endotoxin. It is preferred that the polyene macrolide antibiotic binds to its at least one cognate endotoxin at least two-fold, at least five-fold, at least ten-fold, and most preferably at least fifty-fold more strongly than the at least one other endotoxin. Most preferably, the polyene macrolide antibiotic will not bind to the at least one other endotoxin to any measurable degree.

Binding can be measured by measuring a signal produced by the polyene macrolide antibiotic. In some embodiments, the signal is an optical signal, such as luminescence, fluorescence or absorbance. Therefore, the signal produced by the polyene macrolide antibiotic can be measured using optical methods, for example, luminescence, absorbance or fluorescence spectroscopy. Alternatively, low angle static light scattering and particle size analysis can be used to detect complex formation using, for example, a Zetasizer (available from Malvent Instruments, Ltd.). Other methods suitable for measuring the signal produced by a polyene macrolide antibiotic include electronic absorption spectroscopy, nuclear magnetic resonance spectroscopy, X-ray crystallography, mass spectrometry, infrared and Raman spectroscopy and cyclic voltammetry.

Most naturally-occurring polyene macrolide antibiotics are synthesized by bacteria. The inventors surprisingly discovered that a chemiresistor comprising a thin film of d-RGO functionalized with amphotericin B was highly sensitive to LPS originating in the bacterium, Streptococcus nodusus, the bacterium that produces amphotericin B, but was less sensitive to LPS originating from different bacterial strains. Similarly, a chemiresistor comprising a thin film of d-RGO functionalized with nystatin, which is produced by Streptomyces noursei, was very sensitive to LPS originating from Streptomyces noursei, and less sensitive to LPS originating from Streptococcus nodusus. Natamycin, which is produced by Streptomyces natalensis, a gram positive bacterial strain, is very sensitive to gram positive δ-endotoxins and less sensitive to gram negative endotoxins, such as LPS. Thus, each polyene macrolide antibiotic has at least one cognate endotoxin for which the polyene macrolide antibiotic demonstrates increased sensitivity and selectivity, presumably because the polyene macrolide antibiotic selectively binds to at least the one cognate endotoxin. This selectivity can be exploited in a method to detect an endotoxin produced by a bacterium using a polyene macrolide antibiotic produced by the same bacterium or class of bacteria.

In some embodiments, the present invention is a method for detecting an endotoxin produced by a bacterium in a sample using a polyene macrolide antibiotic produced by the same bacterium (e.g., detecting LPS from Streptococcus nodusus using amphotericin B, detecting LPS from Streptomyces noursei using nystatin, detecting δ-endotoxin from Streptomyces natalensis using natamycin). The method comprises contacting a sensor with a sample, said sensor including a polyene macrolide that selectively binds to an endotoxin, wherein the polyene macrolide antibiotic and the endotoxin are produced by the same bacterium, and measuring a signal produced by the sensor, thereby determining whether an endotoxin produced by a bacterium is present in the sample.

The selectivity of each polyene macrolide antibiotic for at least one cognate endotoxin can be exploited in a multicomponent detector array to simultaneously detect the presence of two or more different endotoxins (e.g., LPS from Streptococcus nodusus, δ-endotoxin from Streptomyces natalensis, endotoxins produced by gram positive bacteria, endotoxins produced by gram negative bacteria) in a sample and, optionally, to identify two or more different endotoxins in the sample.

Another embodiment of the invention is method for identifying an endotoxin in a sample. The method comprises contacting a sensor with a sample, said sensor including a polyene macrolide antibiotic that selectively binds to an endotoxin; and measuring a signal produced by the sensor, thereby determining the identity of the endotoxin in the sample.

Yet another embodiment of the invention is a method for detecting the presence of two or more different endotoxins in a sample. The method comprises contacting an array of at least a first sensor comprising at least a first polyene macrolide antibiotic and at least a second sensor comprising at least a second polyene macrolide antibiotic with a sample, wherein each of at least the first and at least the second polyene macrolide antibiotics selectively binds to at least a first and at least a second endotoxin, respectively, wherein at least the first endotoxin is different from at least the second endotoxin; and measuring a signal produced by at least the first and at least the second sensors, thereby determining whether two or more different endotoxins are present in the sample.

The present invention can also be used to quantify the amount (e.g., concentration) of an endotoxin in a sample by comparing a signal produced by the polyene macrolide antibiotic to a calibration curve or standard curve developed using known quantities of endotoxins. Using partial least square-discriminant analysis (PLS-DA) to analyze fluorescence and absorbance data corresponding to known quantities of endotoxin, endotoxins from unknown samples can be reliably quantified. PLS-DA is a variant of standard PLS regression, in which the block of Y-variables consists of a set of binary indicator variables (one for each class), denoting class membership. A sample has a binary indicator variable set to 1 if it is a member of a given class and, and to 0 otherwise. This is a single-step approach that analyzes all values simultaneously without the need for prior variable selection or stepwise regression and without the rigid constraint of having more samples than variables. This type of analysis can also be used to identify an endotoxin and to discriminate between or identify two or more different endotoxins.

Another embodiment of the invention is method for quantifying the amount of an endotoxin in a sample. The method comprises contacting a sensor including a polyene macrolide antibiotic that binds to an endotoxin with a sample; measuring a signal produced by the sensor; and comparing the signal to a standard curve, thereby determining the amount of the endotoxin in the sample.

Another embodiment of the invention is a method for quantifying the amounts of two or more different endotoxins in a sample. The method comprises contacting an array of at least a first sensor comprising at least a first polyene macrolide antibiotic and at least a second sensor comprising at least a second polyene macrolide antibiotic with a sample, wherein each of at least the first and at least the second polyene macrolide antibiotics selectively binds to at least a first and at least a second endotoxin, respectively, wherein at least the first endotoxin is different from at least the second endotoxin; measuring a signal produced by at least the first and at least the second sensors; and comparing the signal produced by at least the first and at least the second sensors to at least a first and at least a second standard curve, respectively, thereby quantifying the amounts of two or more different endotoxins in the sample.

The methods of detecting, identifying and quantifying endotoxins can be performed simultaneously or in any sequence. In addition, any combination of these methods can be performed. For example, in some embodiments, the invention is a method of detecting and quantifying the amount of an endotoxin or two or more endotoxins in a sample. In other embodiments, the invention is a method of detecting and identifying an endotoxin or two or more different endotoxins in sample. In yet other embodiments, the invention is a method of detecting, identifying, and quantifying the amount of an endotoxin or two or more different endotoxins in a sample.

In some embodiments, the sensors of the invention are incorporated into a device (e.g., chemiresistor, electrochemical device, optical device). Thus, in some embodiments, the methods of the invention employ devices of the invention. For example, a device that includes a sensor including a polymeric material functionalized with a polyene macrolide antibiotic is contacted with a sample and a signal produced by the sensor is measured. By measuring the signal, it is possible to determine whether an endotoxin is present in the sample, how much of an endotoxin is present in the sample, or the identity of the endotoxin in the sample. As used herein, “sensor” refers to the portion of a device that produces the signal, for example, the polymeric material functionalized with a polyene macrolide antibiotic or the polyene macrolide antibiotic.

Another embodiment of the invention is a method of detecting an analyte in a sample, the method comprising, contacting a sensor with a sample, said sensor including a thin film of d-RGO, and measuring the electrical resistance of the sensor, thereby determining whether an analyte is present in the sample. In some embodiments, the electrical resistance of at least a portion of the sensor changes in response to the analyte. In other embodiments, the electrical resistance of at least a portion of the sensor is dependent upon the amount of analyte present in the sample.

The d-RGO-based sensor can be exposed to aqueous base, ultraviolet (UV) light, or UV irradiation in order to induce signal recovery. Therefore, in some embodiments, the method of detecting an analyte in a sample further includes exposing the sensor to aqueous base, UV light, or UV irradiation to return the signal to the baseline signal (i.e., to induce signal recovery).

In some embodiments, the analyte is a gas or vapor. “Vapor,” as used herein, refers to a substance in the gas phase at a temperature lower than its critical point. “Vapors” include nitrogen dioxide, chlorine, sulfur dioxide, chloroform, methanol, ethanol, hexanes, phenol, benzene, and dichloromethane. In other embodiments, the thin film of d-RGO is functionalized with a polyene macrolide antibiotic and the analyte is an endotoxin.

In some embodiments, the methods of the present invention further include the step of measuring a baseline signal produced by the sensor or device in the absence of the sample. In yet other embodiments, the method further includes a pre equilibration step to establish a baseline signal produced by the sensor or device. In one embodiment, the pre-equilibration step includes exposing the sensor or device to a high concentration of analyte (e.g., endotoxin) to condition the sensor or device.

In still yet other embodiments, the methods further include washing the sensor or device in aqueous base (e.g., aqueous sodium hydroxide) to remove bound endotoxin and to return the signal to the baseline signal.

In one embodiment of the present invention, the sensor is incorporated into a chemiresistor, whereby the signal is electrical resistance of the polymeric material functionalized with a polyene macrolide antibiotic, and wherein the value of the electrical resistance of the polymeric material is dependent upon the amount of endotoxin bound to the polyene macrolide antibiotic. In another embodiment of the present invention, the sensor is incorporated into an electrochemical device, whereby the signal is electrical potential of at least a portion of the electrochemical sensor, and wherein the value of the electrical potential of at least a portion of said electrochemical device is dependent upon the amount of endotoxin bound to the polyene macrolide antibiotic. In yet another embodiment, the sensor is incorporated into an optical device, whereby the signal is an optical signal of the polyene macrolide antibiotic and wherein the value of the optical signal is dependent upon the amount of endotoxin bound to the polyene macrolide antibiotic.

The following examples are not intended to limit the scope of the invention in any way.

### EXEMPLIFICATION

### Example 1

### Fluorescence Detection of LPS Using Amphotericin B

Without being limited to any particular theory of the invention, it is believed that amphotericin B selectively binds to LPS. A method of the invention for detecting LPS in a sample incorporates this discovery. The inherent fluorescence of amphotericin B was used to selectively detect bacterial endotoxins, such as LPS. Detection was achieved at room temperature at concentrations as low as 0.001 Endotoxin Units (EU), which equates to 0.2 parts per trillion (ppt) or 20 femtomolar (fM). This sensitivity typically is not achievable using commercially available endotoxin detection techniques, such as the LAL assay.

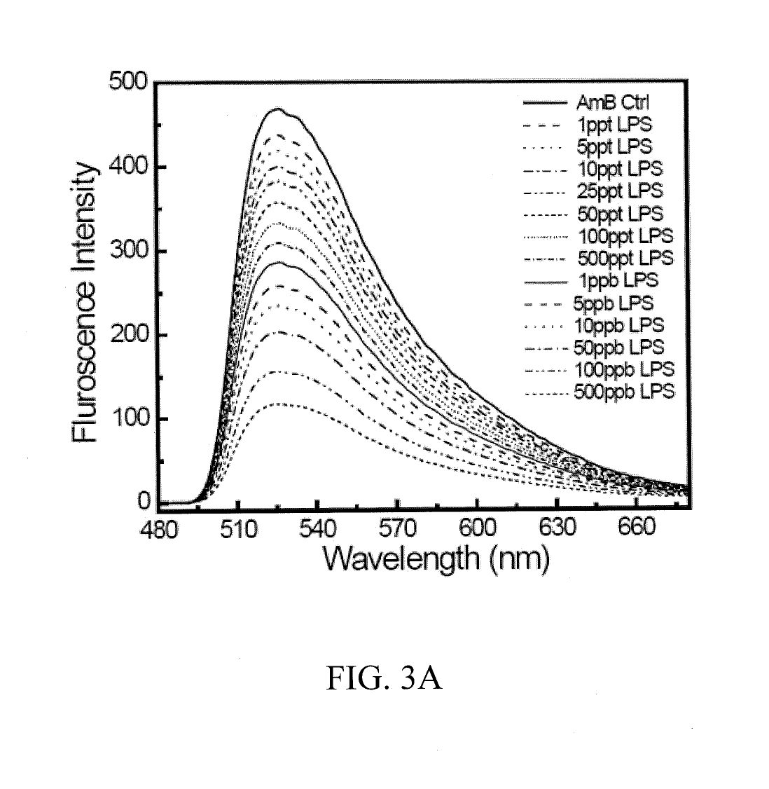

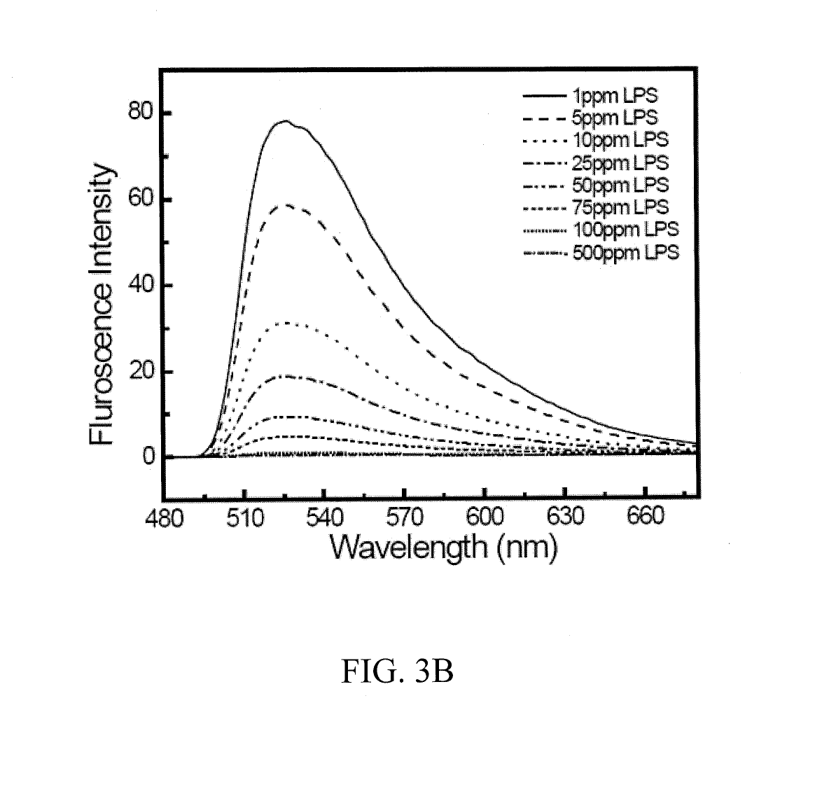

A 50 μg/ml-aqueous solution of amphotericin B was exposed to an aqueous solution of LPS having concentrations of LPS ranging from 1 ppt to 500 ppm and then excited at 350 nm. FIG. 3A shows a decrease in the fluorescence of amphotericin B in the presence of concentrations of LPS ranging from 1 ppt to 500 ppb. FIG. 3B shows a decrease in the fluorescence of amphotericin B in the presence of concentrations of LPS ranging from 1 ppm to 500 ppm. The observed fluorescence quenching of amphotericin B by LPS suggests that amphotericin B can be used to detect femtomolar concentrations of LPS.

The anionic phosphate moiety in the lipid-A portion of LPS may play an important role in binding with amphotericin B. For example, the inherent fluorescence of an aqueous solution of amphotericin B was quenched when a small amount of dilute phosphoric acid was added to the solution. No quenching effect was observed when hydrochloric acid, acetic acid, nitric acid, or benzene sulfonic acid was added to an aqueous solution of amphotericin B, suggesting the effect was not pH-related. In addition, no quenching was observed in the presence of fatty chain carboxylates or sugars, other functional groups that were present in the LPS. In other words, the fluorescence quenching observed in the presence of LPS could have been due to the phosphate functional group present in LPS.

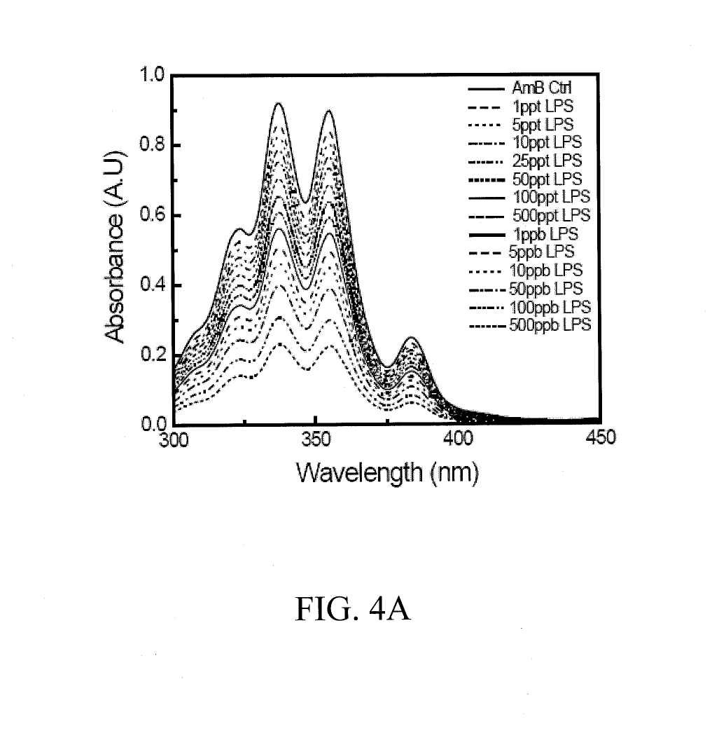

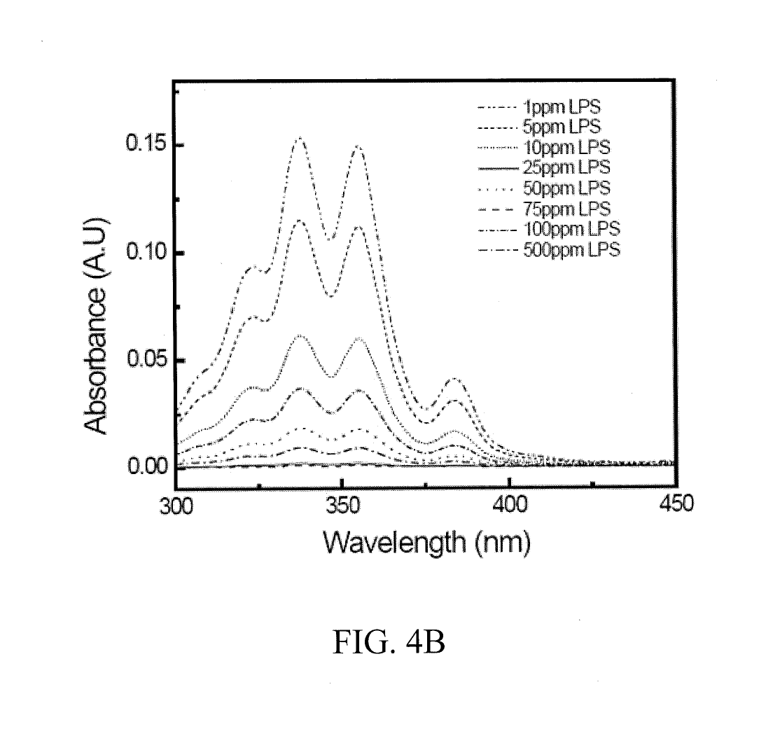

The absorbance spectra of the solutions used to obtain the fluorescence spectra illustrated in FIGS. 3A and 3B were also recorded, and show that the absorbance of amphotericin B decreases upon exposure to increasing amounts of LPS. FIG. 4A shows the decrease in absorbance of amphotericin B upon exposure to low concentrations of LPS (1 ppt to 500 ppb). FIG. 4B shows the decrease in absorbance of amphotericin B upon exposure to high concentrations of LPS (1 ppm to 500 ppm). Like the fluorescence quenching described earlier, the decrease in absorbance has been exploited to detect LPS.

Formation of the amphotericin B-LPS complex was accompanied by changes in the optical spectra of amphotericin B solutions, even at very low concentrations of LPS (ng/mL).

### Example 2

### Electrochemical Detection of LPS Using Polyaniline (PANI) Functionalized with Amphotericin B

The synthesis of a covalent PANI-amphotericin B complex was undertaken in order to test whether an electrochemical sensor including a covalent PANI-amphotericin B complex could be used to detect LPS. Using this method, concentrations of LPS as low as 50 ng/mL were detected.

Nanofiber seeding was used to synthesize a covalent PANI-amphotericin B complex, and these amphotericin B-functionalized polymers were used, in turn, for the biochemical detection of LPS. Nanofiber seeding was used to synthesize bulk quantities of nanofibers of major classes of conducting polymers in one step from the monomers using precipitation polymerization. A very small (seed) amount of nanofibers of known chemical composition was added just prior to the onset of oxidative polymerization of, for example, aniline, pyrrole, thiophene, or ethylenedioxythiophene (PEDOT). Polymerization was triggered on the surface of the seed nanofibers, which caused the bulk morphology of the polymer precipitate to change from granular to nanofibrillar. The seed nanofibers were not covalently bound to the precipitate and were easily washed away in some instances. The resulting polymers were chemically indistinguishable from those prepared without seeding. By choosing a “seed” having reactive functional groups, it was possible to obtain bulk polymer covalently linked to the seed.

The oxidative polymerization of aniline was carried out using ammonium peroxydisulfate in dilute aqueous acid in the presence of less than 0.5% amphotericin B. To 30 mL of 1M hydrochloric acid were added 2 mL of aniline monomer and 5 mg of amphotericin B. After 5 minutes of stirring, an aqueous solution of 1.15 g of ammonium peroxydisulfate in 20 mL of hydrochloric acid was added with continuous stirring. The reaction was monitored using potential time profiling by monitoring the open circuit potential (V_{OC}) continuously with reaction time. After 3 hours, the product was filtered and washed with copious amounts of 1M hydrochloric acid to remove any excess ammonium peroxydisulfate. The product obtained was green in color (emeraldine salt), which is attributed to the doping of the polymer backbone by hydrochloric acid. The amphotericin B-seeded PANI thus obtained was dedoped in 0.1 M ammonium hydroxide for 12 hours to obtain a blue product (emeraldine base). A film of the dedoped polymer dissolved in NMP was then cast on a platinum mesh for use as an electrochemical sensor.

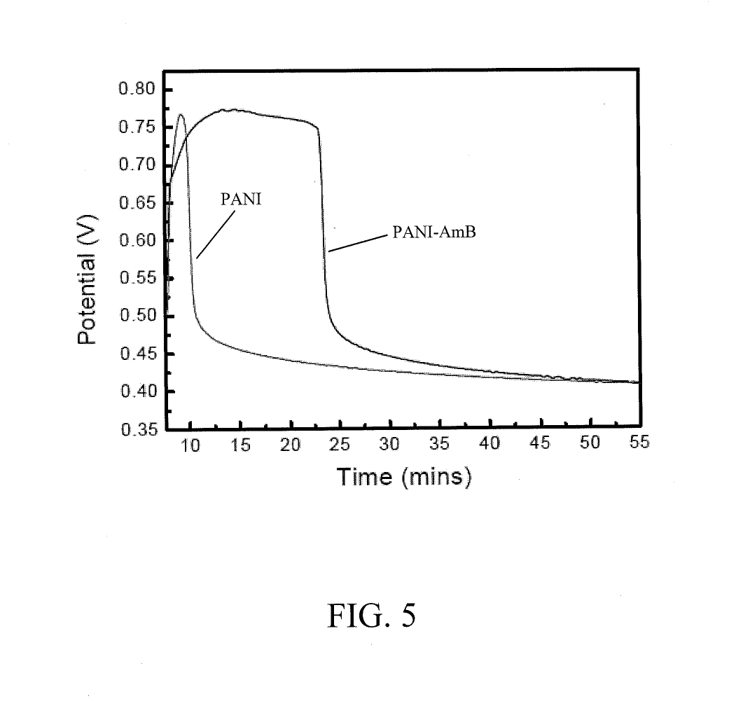

Surprisingly, the reaction kinetics of the polymerization seeded with amphotericin B were dramatically different than the reaction kinetics of the same polymerization carried out in the absence of amphotericin B. Continuous monitoring of the open circuit potential (V_{OC}) of both the unseeded control polymerization reaction and the amphotericin B-seeded polymerization reaction revealed that the approximately 7-minute induction period normally observed was extended to approximately 25 minutes in the amphotericin B-seeded system. FIG. 5 shows that seeding with amphotericin B affected the kinetics of the oxidative polymerization of aniline.

The amphotericin B-seeded reaction also looked very different than the unseeded control. The amphotericin B-seeded reaction gradually turned yellow, brown, dark brown, red and, suddenly, dark green. The appearance of the green color was accompanied by rapid precipitation of the conducting polyaniline powder. In contrast, the unseeded control turned light green, then dark green without any intervening colors. The PANI powder (emeraldine hydrochloride) synthesized in the amphotericin B-seeded system was dried and dedoped in 0.1 M ammonium hydroxide for 12 hours, then analyzed spectroscopically and electrochemically.

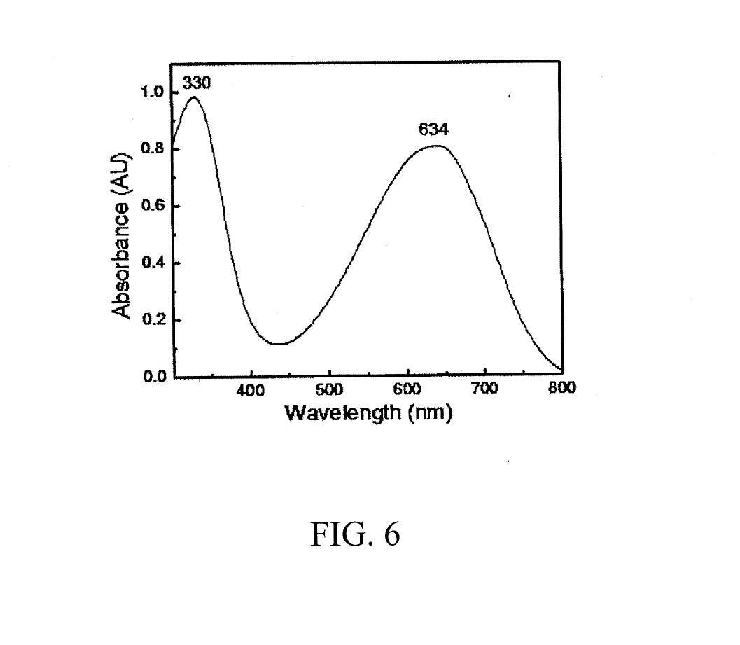

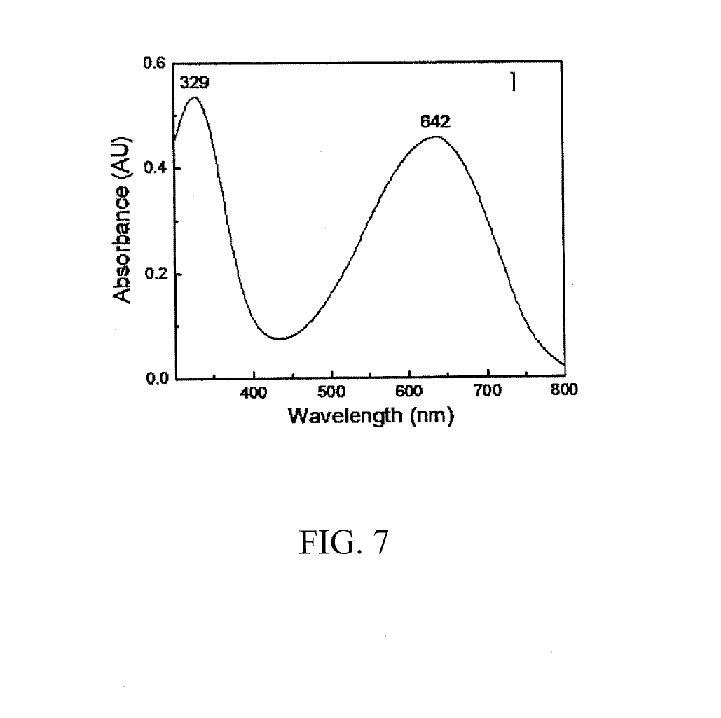

Changes in the absorbance spectrum of the PANI-amphotericin B polymer were measured. FIG. 6 is an absorbance spectrum of PANI and shows the absorbance of PANI over a range of wavelengths. FIG. 7 is an absorbance spectrum of a PANI-amphotericin B conjugate and shows the absorbance of the conjugate over a range of wavelengths. A comparison of FIGS. 6 and 7 reveals that the characteristic 634-nm excitonic transition of emeraldine base solution in NMP was red-shifted to 642 nm in the amphotericin B-seeded system. This red-shift signifies that the PANI-amphotericin B conjugate has a lower energy excitonic transition, which may be due to increased conjugation of the polymer backbone resulting from covalent functionalization of PANI with amphotericin B.

The electrochemical characteristics of the polymers were analyzed using a three-electrode device, such as that illustrated in FIG. 2, including a working electrode, a counter electrode and a reference electrode. The working electrode was platinum foil coated with a thin film of unseeded PANI or PANI functionalized with amphotericin B. The counter electrode was a bare platinum wire. The reference electrode was silver-silver chloride. In principle, the electrode material could be any conducting material, for example, graphite, graphene, glassy carbon, gold, plastic or glass coated with indium-tin-oxide, or unfunctionalized carbon nanotubes.

The electrode coated with unseeded control polymer and the electrode coated with amphotericin B-seeded polymer showed striking differences in their cyclic voltammograms. For example, the half-wave potential (E_{1/2}) of the first redox peak, which corresponds to oxidation of the fully reduced leucoemeraldine oxidation state to the half oxidized emeraldine oxidation state is shifter by +30 mV in the case of the electrode coated with amphotericin B-seeded polymer. This is consistent with some degree of covalent functionalization of the polyaniline backbone, presumably by amphotericin B. An electrode coated with a physical mixture of PANI and amphotericin B did not produce this shift. The amphotericin B-seeded polymer also had a higher conductivity (17-20 S/cm) compared to the unseeded control (1-5 S/cm).

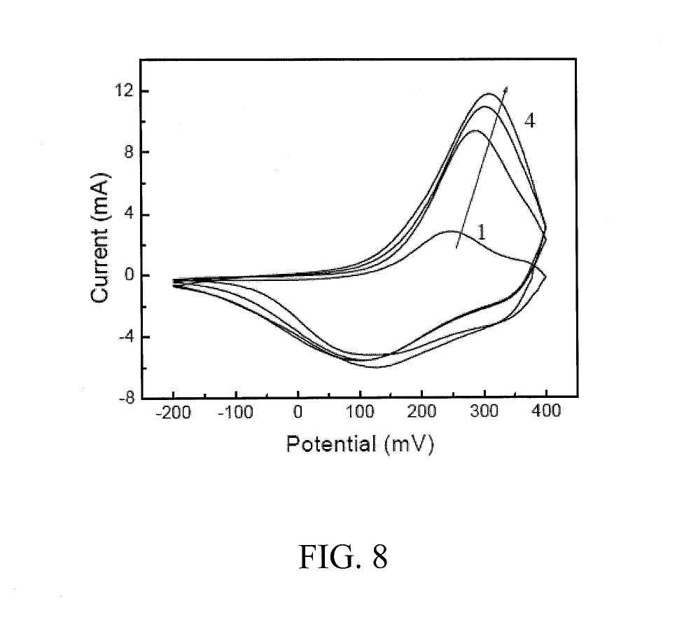

FIG. 8 shows the first redox cycle of a PANI-amphotericin B conjugate upon successive additions of LPS. The first redox peaks shifted to higher potentials, e.g., from 0.15 V to 0.23 V (versus Ag/AgCl), upon progressive addition of LPS. Surprisingly, the PANI-amphotericin B conjugate became progressively more electroactive upon addition of LPS.

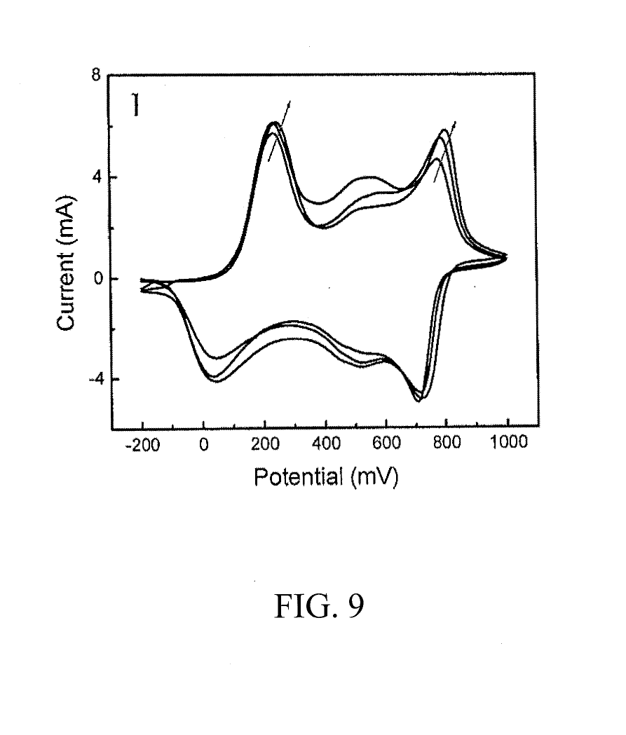

FIG. 9 shows both redox cycles of a PANI-amphotericin B conjugate upon successive additions of LPS. The peaks in the cyclic voltammograms of the amphotericin B-seeded polymer shifted to higher voltages (to the right in FIGS. 8 and 9) in response to increasing concentrations of LPS, suggesting that LPS binding to amphotericin B increases the oxidation potential of the PANI-amphotericin B conjugate. FIGS. 8 and 9 also show that addition of LPS resulted in a significant increase in the electroactivity of the PANI-amphotericin B conjugate. The increase in electroactivity was manifested in the cyclic voltammograms as an increase in peak amplitude. This effect could be exploited to increase the sensitivity of the electrochemical sensor, thereby decreasing the detection limit.

The change in the electrochemistry of the PANI-amphotericin B conjugate (60:1 polyaniline:amphotericin B) was due to covalent functionalization of the PANI backbone because there was no corresponding change in the cyclic voltammetry when the electrode film was cast from a solution containing a 60:1 physical mixture of polyaniline:amphotericin B. Sensitivity to LPS was observed only if the polymerization reaction was carried out in the presence of amphotericin B.

### Example 3

### Flexible, Organic Sensor for LPS Detection Using Single-Walled Carbon Nanotubes

The synthesis of a flexible and lightweight chemiresistor made of a thin film composed of single-walled carbon nanotubes functionalized with amphotericin B was undertaken to determine if a sensor based on this material could be used to selectively detect endotoxins (e.g., LPS). Detection was achieved at room temperature with a detection limit well below the clinical detection limit of endotoxins.

An aqueous dispersion of nanotubes and amphotericin B (10:1 ratio) was prepared by probe sonication. The resulting dispersion was significantly more stable than a dispersion prepared without amphotericin B, suggesting that amphotericin B conferred hydrophilic character to the nanotubes. Although not wishing to be bound by any particular theory, it is believed that the polyene functionality interacted with the surface of the nanotubes, while the hydroxyl groups of amphotericin B faced away from the nanotubes, toward the aqueous solution. There was no change in the radial breathing modes in the Raman spectrum of the amphotericin B-nanotube suspension, which was consistent with non-covalent functionalization. Single-electron microscopy (SEM) images showed that the nanotubes were mainly in the form of microns-long, approximately 20-nm diameter bundles, or ropes, and not in the form of individual tubes. However, the superior quality of the dispersion was similar to DNA- or peptide-functionalized carbon nanotubes, where some degree of de-bundling took place. It is possible, therefore, that amphotericin B completely covered the nanotube surface (i.e., wrapped around the nanotube).

In a second experiment, the stability of an aqueous dispersion of nanotubes and amphotericin B containing Triton X-100 was compared to an aqueous dispersion of nanotubes and amphotericin B without Triton X-100. The dispersion containing Triton X-100 was prepared by adding 10 mg single-walled carbon nanotubes and 5 mg amphotericin B to 15 mL de-ionized water containing 100 mg of Triton X-100. The mixture was sonicated in a bath (Fisher Scientific FS30H) for 20 minutes, then was probe sonicated five times for five minutes each time using the Fisher Scientific 550 Sonic Dismembrator. The dispersion obtained was stable for a period of 6 months.

The dispersion without Triton X-100 was prepared by adding 10 mg single-walled carbon nanotubes and 10 mg amphotericin B to 15 mL deionized water. The mixture was sonicated in a bath (Fisher Scientific FS30H) for 20 minutes, then was probe sonicated five times for five minutes each time using the Fisher Scientific 550 Sonic Dismembrator. The dispersion without Triton X-100 was stable for a period of 2 weeks. The stability of the aqueous dispersion was enhanced by the presence of Triton X-100.

A chemiresistor made of a thin film of carbon nanotubes functionalized with amphotericin B was constructed by inkjet printing an aqueous suspension of carbon nanotubes functionalized with amphotericin B (with or without Triton X-100) on a polyethylene terephthalate substrate. The ink from a cartridge of a Hewlett Packard 4250 inkjet printer was replaced with the nanotube-amphotericin B dispersion. Isopropanol (0.05 mL) was added to the dispersion in the cartridge, and the cartridge was mounted in the printer. A pattern designed using Microsoft PowerPoint was ink jet printed on transparency paper using 10 passes.

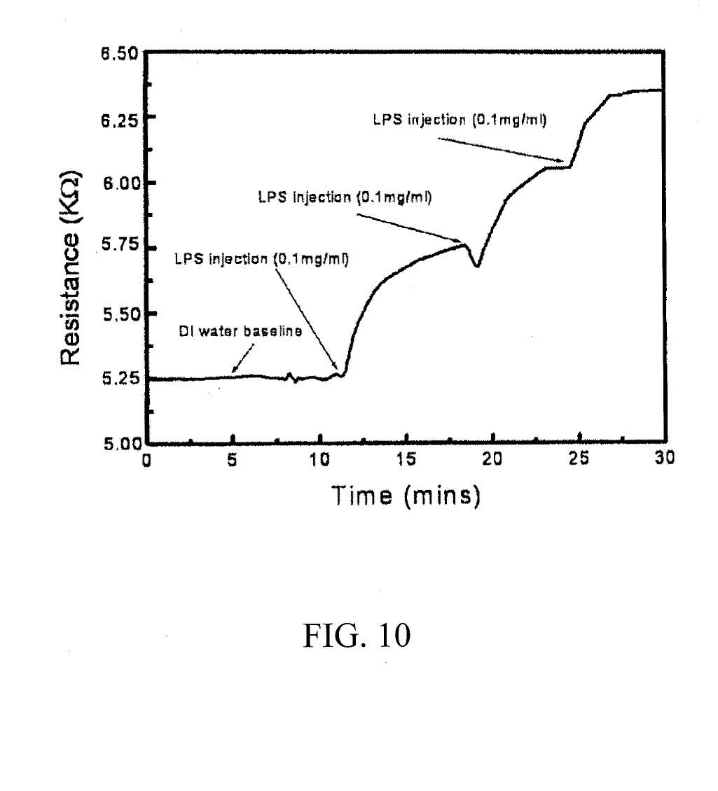

The chemiresistor thus obtained included a plastic substrate and a sensor element consisting of a thin film of carbon nanotubes non-covalently functionalized with amphotericin B. The chemiresistor was dipped in a water bath, such that the sensor element was submerged, and a baseline resistance reading was taken. Three successive injections of LPS (0.1 mg/mL) were then made and the resistance monitored. FIG. 10 is a graph of the resistance of a single-walled carbon nanotube-amphotericin B sensor as a function of time, and shows that upon addition of LPS, the resistance of the biosensor increased, indicating that amphotericin B-LPS binding could be detected using an amphotericin B-functionalized chemiresistor.

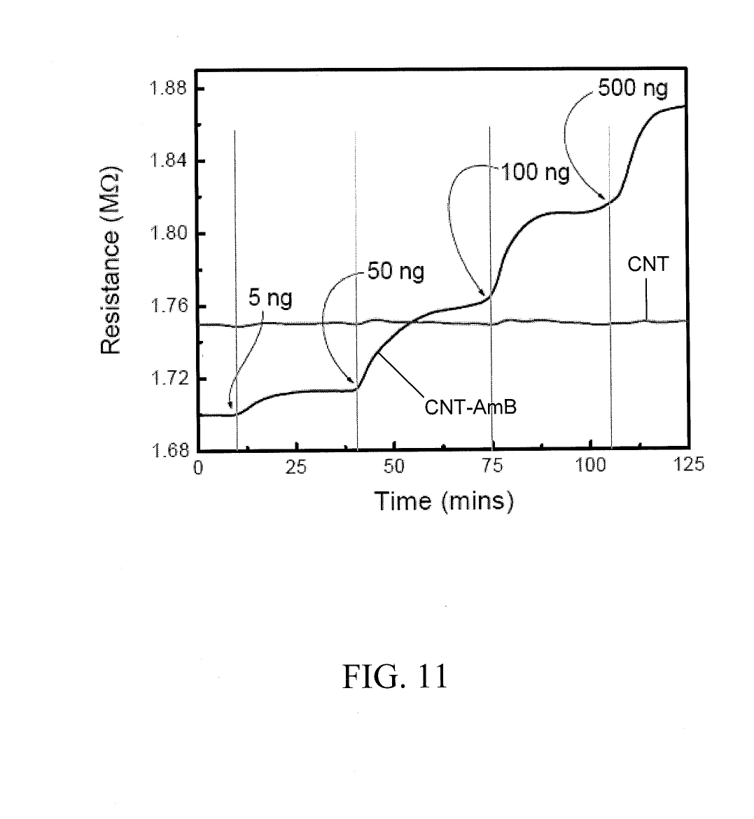

In another experiment, the resistance of the amphotericin B-functionalized nanotubes upon exposure to LPS were compared to the resistance of unfunctionalized nanotubes. FIG. 11 is a graph of the resistance of a single-walled carbon nanotube-amphotericin B sensor and a single-walled carbon nanotube as a function of time, and shows that the resistance of the amphotericin B-functionalized nanotubes increased in response to increasing concentrations of LPS. The resistance of the nanotube-amphotericin B film changed in a reliable and reproducible fashion, whereas unfunctionalized nanotube registered no change in resistance. Importantly, similar results were obtained with LPS dissolved in bovine serum albumin, suggesting that the nanotube-amphotericin B sensor was insensitive to several potential biological interferents like serum proteins. The biosensor thus fabricated showed a specific affinity for LPS. However, the detection limit was approximately 2-5 EU/mL, as compared to a detection limit of 0.005 EU/mL using the optical method described in Example 1, and the signal could not be reversed, meaning the biosensor was suitable for a single use only.

### Example 4

### Sensor for Endotoxin Detection Using Double-Reduced Graphene Oxide (dr-GO) and Amphotericin B or Natamycin

A new form of graphene, called double-reduced graphene oxide (d-RGO), was used to detect endotoxins. The d-RGO was functionalized with amphotericin B or nystatin and the resulting composite was used as a sensor to detect LPS. A chemiresistor made of a thin film of d-RGO non-covalently functionalized with amphotericin B or nystatin, when exposed to endotoxins (LPS), showed a reliable and reproducible increase in resistance.

Graphene oxide (GO) was synthesized using Hummer's method. In a typical procedure, graphite nanoplatelets (2 g) and NaNO₃ (1 g) were added to 50 mL concentrated H₂SO₄ and magnetically stirred. The black mixture was cooled to 0° C. in an ice bath and solid KMnO₄ (6 g) added slowly over a period of 45 minutes to ensure that the temperature did not rise above 10° C. The ice bath was then removed and the temperature of the reaction mixture was allowed to rise to room temperature. The reaction vessel was then placed in a warm water bath and the temperature maintained at approximately 35° C. for approximately 30 minutes when a vigorous effervescence was observed. As the reaction progressed, the color changed to brownish-grey, the effervescence diminished, and the contents became viscous. After 30 minutes, deionized (D.I.) water (approximately 90 mL) was added slowly to the brownish-grey paste, causing a violent effervescence and an increase in temperature to approximately 98° C. After 15 minutes at 98° C., the brown-colored suspension was further diluted to 280 mL with warm water and treated with 5 mL aqueous H₂O₂ (35 weight percent) to reduce unreacted KMnO₄ and MnO₂ to colorless and soluble MnSO₄. The crude GO powder was filtered and repeatedly centrifuged/washed with aqueous 1M HCl and D.I. water until the pH of the supernatant was approximately 7. The bright yellow GO powder was dried in a vacuum oven for 12 hours.

The bright yellow GO powder was then dispersed in D.I. water at a concentration of 3 mg/mL. This mixture was then subjected to electrolysis via a DC power supply of 18 V. Heavy bubbling was observed at the anode and after 48 hours a brown-black precipitate was obtained at the cathode. The precipitate was electrochemically reduced graphene oxide (e-RGO). The precipitate was filtered, washed, and then dried in a vacuum oven for 12 hours.

To 5 mL of a stirred aqueous brown-black dispersion of e-RGO (3 mg/mL) was added 5 g of ascorbic acid. The reaction mixture was heated to approximately 80° C. for 1 hour. The color of the dispersion changed gradually over a period of about 10 minutes to black, signaling reduction of e-RGO to double-reduced graphene oxide (d-RGO). The color change was accompanied by flocculation. The d-RGO was centrifuged and washed five times with 15 ml D.I. water each time, with centrifugation after each wash. The d-RGO thus obtained was in the form of few-layer graphene sheets and x-ray photoelectron spectroscopy (XPS) showed that it was virtually defect-free. As a control, GO that has not been subjected to electrolysis was reduced with ascorbic acid using the procedure described above.

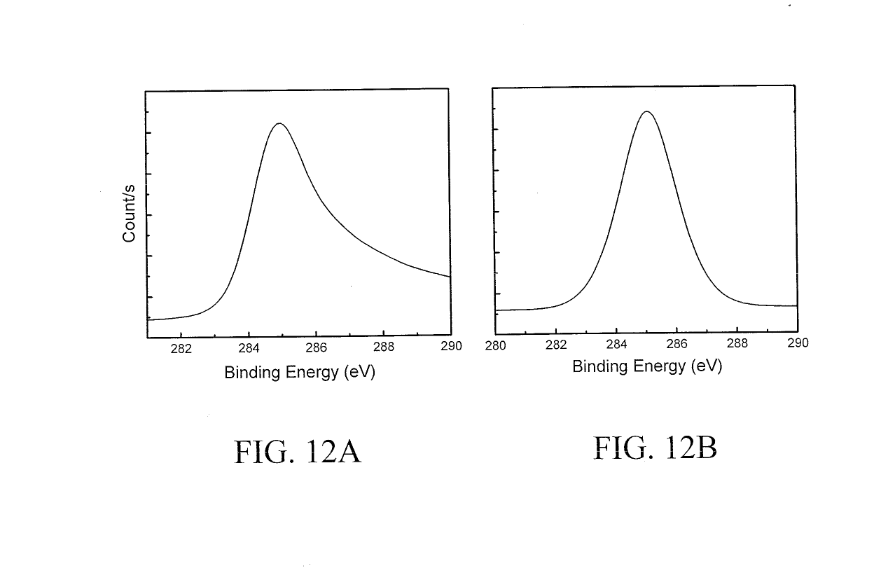

FIGS. 12A and 12B are graphs obtained using x-ray photoelectron spectroscopy of counts for the carbon peak of GO treated with ascorbic acid only (FIG. 12A) and d-RGO (FIG. 12B) as a function of binding energy (eV). The peak in FIG. 12A has a shoulder at 286.5 eV that is not present in the peak in FIG. 12B. The shoulder at 285.6 eV can be attributed to unreduced carbonyl groups in the control RGO. In contrast, the peak in FIG. 12B is symmetrical, indicating that the d-RGO produced by electrochemical then chemical reduction is defect-free.

The black d-RGO powder was functionalized, separately, with amphotericin B and nystatin by suspending 5 mg d-RGO in 15 mL water containing 5 mg of amphotericin B or nystatin and 40 mg Triton X-100. The fine dispersion thus obtained was probe sonicated for 25 minutes in 5 cycles of 5 minutes each.

Sensors were prepared via drop casting of the d-RGO dispersion on an interdigitated (IDA) gold pattern. The IDA gold pattern was then dried and washed in toluene to remove excess Triton X-100. Sip sockets were then attached to the pattern to establish electrical contacts. The initial baseline in D.I. water was monitored to check for sensor stability in aqueous medium. The medium was then spiked with varying concentrations of endotoxin and the response obtained showed an increase in the resistance of the sensor as a function of time. A quick wash in aqueous base enabled signal reversibility under ambient conditions.

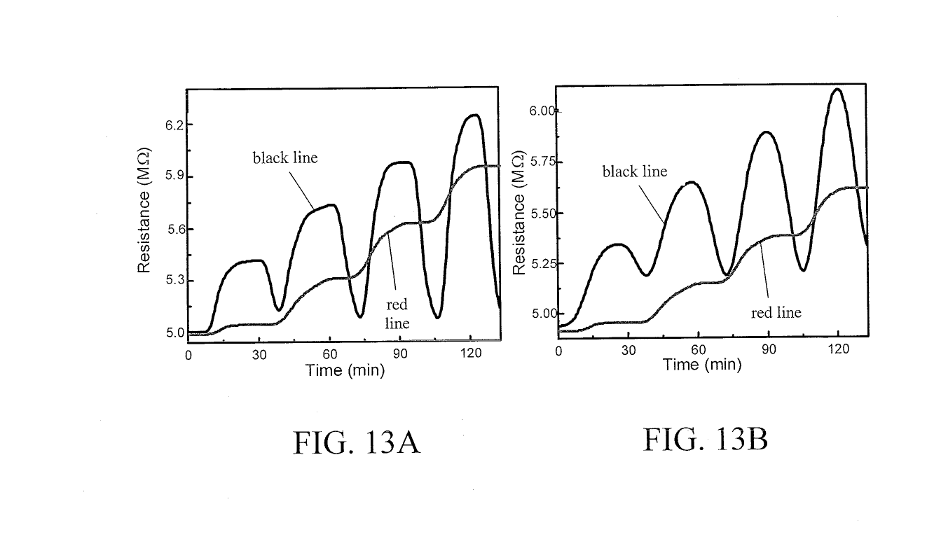

FIGS. 13A and 13B are graphs of the resistance (MΩ) of an amphotericin B- or nystatin-functionalized d-RGO chemiresistor upon successive additions of 0.05 EU/mL LPS (red line) and upon successive additions of 0.05 EU/mL LPS alternating with washing in aqueous base to reverse the signal (black line), as a function of time (minutes). FIGS. 13A and 13B show that, when functionalized with amphotericin B or nystatin, d-RGO can be used to detect LPS at concentrations as low as 0.05 EU/mL. Sensors utilizing RGO synthesized by conventional chemical (e.g., ascorbic acid reduction only, hydrazine reduction only) or electrochemical methods, were also tested, but no change in the resistance of these sensors was observed upon addition of LPS.

Several known interferents, such as di- and tri-phosphates, phosphoric acid, carboxylic acid, hydrochloric acid, sulfuric acid, nitric acid, sugars and lipids (saturated and unsaturated) were also tested without any alarming results.

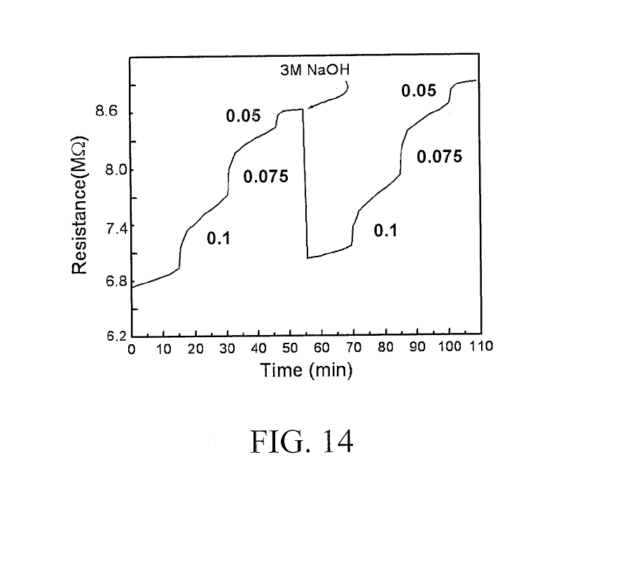

FIG. 14 is a graph of the resistance of an amphotericin B-functionalized d-RGO on PET upon successive additions of LPS and upon dipping in 3 M NaOH as a function of time. FIG. 14 shows that a d-RGO-AmB-based chemiresistor film can be used to detect LPS at concentrations as low as 0.05 EU/mL. In addition, by simply dipping the film in 3 M NaOH, the signal can be reversed back to the baseline resistance of the film, meaning the biosensor can be re-used.

### Example 5

### Synthesis and Characterization of Polyaniline Tetramer-Amphotericin B Complex

Aniline dimer was chemically coupled to amphotericin B, and the resulting complex was used to detect LPS.

A platinum mesh was immersed in a 100-mL beaker containing a magnetically-stirred suspension of 0.5 g 4-aminodiphenylamine (4-ADPA, or aniline dimer) and 5 mg amphotericin B in 30 mL aqueous 1.0M HCl. A 20 mL solution of ammonium peroxydisulfate (1.15 g) in aqueous 1.0 M HCl was added all at once to initiate the reaction. The contents of the reaction flask turned green upon addition of the ammonium peroxydisulfate. The reaction was stirred for about 1 hour at room temperature (21° C.). The amphotericin-functionalized aniline tetramer product was suction filtered and washed thoroughly with aqueous 1.0 M HCl, then dried in air.

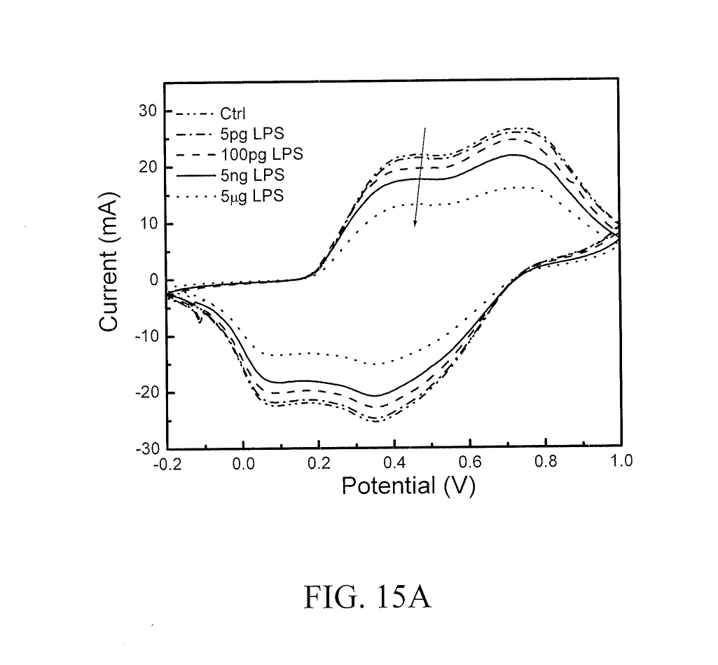

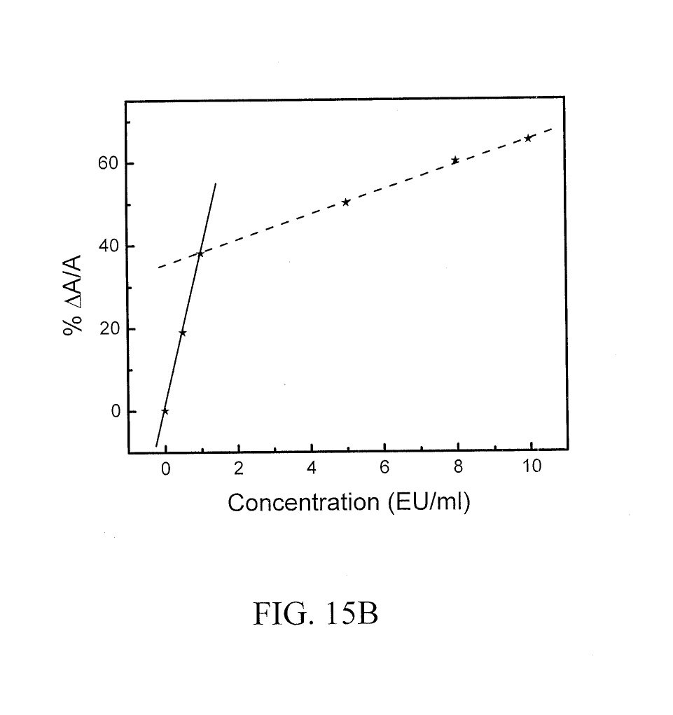

During the reaction, a green film of the product also deposited on the platinum mesh. This green film was used directly for electrochemical measurements. FIG. 15A is a cyclic voltammogram of the aniline tetramer-amphotericin B conjugate upon successive additions of LPS. FIG. 15A was obtained by repeatedly scanning the voltage between −0.2 V and 1.0 V at a scan rate of 20 mV/s using Ag/AgCl as the reference. After 10 cycles, the plot stabilized. The eleventh cycle was used as the control plot (0.00 EU/mL LPS) in FIG. 15A. At the beginning of the twelfth cycle, at a voltage of −0.2 V, LPS was added in the amounts indicated in FIG. 15A. The voltage was scanned at 20 mV/s and the change in the amplitude of the current response was measured. The amplitude of the signal corresponding to the current decreased with increasing concentrations of LPS.

This tetramer-amphotericin B complex exhibited unusual electrochemical behavior when compared to PANI-amphotericin B in that: (i) it was very stable electrochemically, even at voltages as high as 1 V (versus SCE), (ii) the signal decreased upon exposure to LPS, (iii) the detection limit was much lower (0.5 EU/mL) than the detection limit of PANI-amphotericin B (10 EU/mL)

### Example 6

### Robustness of Endotoxin Detection Using Amphotericin B in the Presence of Potential Interferents

The robustness of the endotoxin detection methods disclosed herein were assessed in the presence of potential interferents.

To assess the robustness of endotoxin using an optical method, a baseline fluorescence curve was obtained using a 50 μg/ml aqueous solution of amphotericin B (excitation at 350 nm and emission at 526 nm). The change in fluorescence was monitored upon addition of the interferents shown in Table 1. To 2 mL of the amphotericin B solution was added 1.0 mL of the following interferents: serum albumin (1.0 mL of a 1 mg/mL solution), ethanol (pure, 1.0 mL), phosphoric and hydrochloric acids (1.0 mL of aqueous 1 M solution), glycerol (pure, 1.0 mL), blood plasma (1.0 mL), monosaccharides, e.g., glucose, fructose and sucrose (1.0 mL of a 1 mg/mL solution), fatty acids, e.g., oleic acid, adipic acid (pure, 1.0 mL), acetone (pure, 1.0 mL).

In order to assess the robustness of endotoxin detection using a d-RGO-based sensor, the sensor was exposed to various interferents shown in Table 1 and the change in resistance of the sensor was measured. A baseline resistance of an amphotericin B- or nystatin-functionalized d-RGO chemiresistor was established. The sensor was then immersed in 50 mL D.I. water and 1.0 mL of the following interferents were added: serum albumin (1.0 mL of a 1 mg/mL solution), ethanol (pure, 1.0 mL), phosphoric and hydrochloric acids (1.0 mL each of an aqueous 1M solution), glycerol (pure, 1.0 mL), blood plasma (1.0 mL), monosaccharides, e.g., glucose, fructose and sucrose (1.0 mL of a 1 mg/mL solution), fatty acids, e.g., oleic acid, adipic acid (pure, 1.0 mL), acetone (pure, 1.0 mL). No significant change in resistance was observed. In contrast, lipids and proteins are known to interfere with the LAL assay.

Table 1 shows that both the optical method of detecting LPS described in Example 1 and the electrochemical method of detecting LPS described in Example 4 are insensitive to the presence of potential interferents. For example, even though endotoxins are composed of sugars, long alkyl chains and acidic groups, there was no change in either the optical or electrical signal when these components were added separately to a solution of amphotericin B and LPS. There was also no change in either the optical or electrical signal in the presence of components typically present in the bloodstream (e.g., albumin, lipids, proteins). In contrast, lipids and proteins are known to interfere with the LAL assay. This data suggests that the detection technology based on the polyene macrolide antibiotic-endotoxin complex is very selective to endotoxins, and can tolerate a wide range of interferents.

TABLE 1
Robustness of endotoxin detection using amphotericin B
in the presence of potential interferents

| | OPTICAL | ELECTRICAL |
|---|---|---|
| | Fluorescence & | d-RGO film |
| Interferents | Absorbance | Resistance |
| Serum Albumin | ✓ | ✓ |
| Alcohols | ✓ | ✓ |
| Acids | ✓ | ✓ |
| Glycerol | ✓ | ✓ |
| Blood Plasma | X | ✓ |
| Monosaccharides | ✓ | X |
| Fatty acids | ✓ | ✓ |
| Ketones | ✓ | ✓ |
| Gram +ve bacteria | ✓ | ✓ |

✓ - had no effect on endotoxin detection
X - not tested

### Example 7

### Comparison of Commercially Available Endotoxin Detectors and the Optical and Electrical Methods Described Herein

Table 2 is a competitive analysis of how the optical, electrical, and electrochemical endotoxin detection methods described in Examples 1, 4, and 5, respectively, compare with existing technologies, in particular, the LAL method (available from Camblex, Charles River Laboratories International, Inc., and Associates of Cape Cod) and a new non-LAL fluorescence-based method from Charles River Laboratories International, Inc. It is important to note that the optical system described in Example 1 does not require measurement of both fluorescence and absorbance; measuring a change in either fluorescence or absorbance is all that is required, which greatly simplifies the instrumentation and reduces cost.

TABLE 2
Comparison between commercially available LPS detectors and the
optical and electrical methods described herein

| | | | d-RGO- | Tetramer- | |
|---|---|---|---|---|---|
| Desired | | Charles | AmB | AmB | |
| Properties | LAL¹ | River² | resistance | electrochem | Optical |
| Endotoxin | Ex- | Good | Good | Good | Excellent |
| response | cellent | | | | |
| High | 0.005 | 0.02 EU | 0.05 EU | 25 EU | 0.001 EU |
| sensitivity | EU | | | | |
| Interferents | | | Good | Good | Excellent |
| Fast response | Long | 15 | 15 | 1 minute | 5 minutes |
| time | | minutes | seconds | | |
| Low start-up | Poor | <1 | <1 minute | <1 minute | <1 minute |
| time | minute | | | | |
| Portable | No | Yes | Yes | Yes | Yes |
| Low operator | Poor | On/off | On/off | On/off | On/off |
| skills | | | | only | |
| Environments | Limited | Robust | Robust | Robust | Robust |
| Unit cost | | | <$200 | <$200 | |

¹Horseshoe crab assay, the industry standard;
²Fluorescence-based commercial detector available from Charles River Laboratories International, Inc.

### Example 8

### Detecting Different Endotoxins Using Different Polyene Macrolide Antibiotics

Many endotoxin detection methods only test for gram negative endotoxins, like LPS, since gram negative endotoxins constitute a majority of sepsis cases. However, there are a significant number of endotoxins produced by gram positive bacteria, including δ-endotoxins. The inventors surprisingly discovered that gram positive endotoxins, such as δ-endotoxin, can be detected using polyene macrolide antibiotics produced by gram positive bacteria.

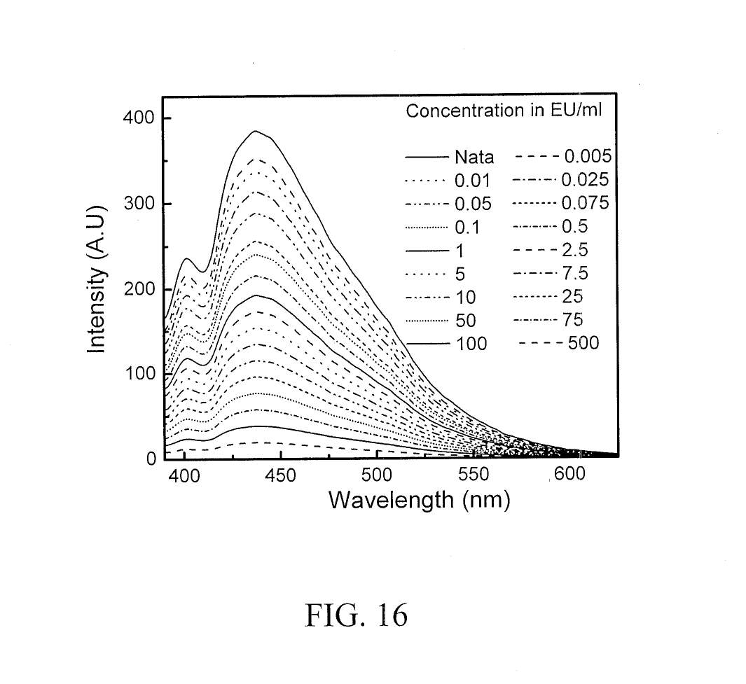

For example, natamycin is a polyene macrolide antibiotic from Streptomyces natalensis. Unlike amphotericin B, however, natamycin showed only a weak optical response to LPS. FIG. 16 is a fluorescence spectrum of natamycin as a function of wavelength (nm), and shows the fluorescence of natamycin upon exposure to concentrations of δ-endotoxin ranging from 1 part per trillion (ppt) to 500 ppm. and shows that natamycin can be used to detect δ-endotoxin with a detection limit of about 0.05 EU/mL. FIG. 16 was obtained by exposing a 50-μg/ml aqueous solution of natamycin to aqueous solutions of δ-endotoxin having concentrations ranging from 1 ppt to 500 ppm. FIG. 16 shows a decrease in the fluorescence of natamycin in the presence of concentrations of δ-endotoxin ranging from 1 ppt to 500 ppb. The observed fluorescence quenching of natamycin by δ-endotoxin suggests that natamycin can be used to detect femtomolar concentrations of δ-endotoxins

### EQUIVALENTS

While this invention has been particularly shown and described with references to example embodiments thereof, it will be understood by those skilled in the art that various changes in form and details may be made therein without departing from the scope of the invention encompassed by the appended claims.

The relevant teachings of all references identified herein are incorporated by reference in their entirety.

What is claimed is:

1. A complex, comprising: a polyene macrolide antibiotic and an endotoxin.

2. The complex of claim 1, wherein the endotoxin is selected from the group consisting of a lipopolysaccharide and a δ-endotoxin.

3. The complex of claim 1, wherein the polyene macrolide antibiotic is selected from the group consisting of amphotericin B, natamycin, and nystatin.

4. The complex of claim 1, further comprising a polymeric material functionalized with the polyene macrolide antibiotic.

5. The complex of claim 4, wherein the polymeric material includes a material selected from the group consisting of polyaniline, polypyrrole, polythiophene and polyethylenedioxythiophene, or a ring- or an N-substituted derivative thereof, a nanotube or a double-reduced graphene oxide.

6. A device, comprising:
a) a polymeric material functionalized with a polyene macrolide antibiotic; and
b) a substrate in contact with the polymeric material.

7. The device of claim 6, wherein the polymeric material is functionalized with a plurality of different polyene macrolide antibiotics.

8. The device of claim 6, wherein the polymeric material includes a material selected from the group consisting of a nanotube and a double-reduced graphene oxide.

9. An electrochemical device, comprising:
a) a working electrode, said working electrode including a polymeric material functionalized with a polyene macrolide antibiotic;
b) a counter electrode; and
c) a reference electrode interposed between the working electrode and the counter electrode.

10. A method of detecting at least one endotoxin in a sample, comprising the steps of:
a) contacting a sensor with a sample, said sensor including a polyene macrolide antibiotic that binds to an endotoxin; and
b) measuring a signal produced by the sensor, thereby determining whether the endotoxin is present in the sample.

11. The method of claim 10, wherein the sensor further includes a polymeric material functionalized with the polyene macrolide antibiotic.

12. The method of claim 11, wherein the sensor is a chemiresistor, whereby the signal is resistance of the polymeric material, and the value of the resistance of the polymeric material is dependent upon the amount of endotoxin bound to the polyene macrolide antibiotic.

13. The method of claim 12, wherein the sensor is an electrochemical sensor, whereby the signal is electrical potential of at least a portion of the electrochemical sensor, and the value of the electrical potential of at least a portion of said electrochemical sensor is dependent upon the amount of the endotoxin bound to the polyene macrolide antibiotic.

14. A method for identifying an endotoxin in a sample, comprising the steps of:
a) contacting a sensor with a sample, said sensor including a polyene macrolide antibiotic that selectively binds to an endotoxin; and
b) measuring a signal produced by the sensor, thereby determining the identity of the endotoxin in the sample.

15. A chemiresistor, comprising: a thin film of double-reduced graphene oxide in electrical communication with an instrument that measures electrical resistance of double-reduced graphene oxide.
